(19) United States
(12) Patent Application Publication
(10) Pub. No.: US 2009/0179138 A1
(43) Pub. Date: Jul. 16, 2009

(54) Soft mold and fabrication method thereof

(75) Inventors: Sheng-Shin Guo, Taipei (TW); Chia-Yang Chang, Hsinchu (TW); Teng-Sheng Chen, Hsinchu (TW); Yun-Lien Hsiao, Taipei (TW); Jung-Jung Kuo, Hsinchu (TW)

Correspondence Address: Joe McKinney Muncy, PO Box 1364, Fairfax, VA, 22038-1364, US

(73) Assignee: VisEra Technologies Company Limited

(21) Appl. No.: 12/007,887

(22) Filed: Jan. 16, 2008

(51) Int. Cl. B29C 33/56; B29C 41/52

(52) U.S. Cl. 249/114.1; 264/40.5

(57) ABSTRACT

Soft mold and fabrication method thereof. The soft mold of the present invention comprises: a polymer layer having a printing pattern on a first surface thereof; at least one air channel on the first surface; and a back-plate attached to a second surface of the polymer layer. Additionally, the method for fabricating the soft mold includes: providing a mold having a predetermined pattern; positioning the mold in a cavity and calibrating the horizontal thereof; forming a polymer layer on the mold; attaching a back-plate to a top surface of the polymer layer and the dam; separating the polymer layer from the mold, wherein the polymer layer has a patterned surface; and cutting at least one air channel on the patterned surface of the polymer layer.

### BACKGROUND OF THE INVENTION

1. Field of the Invention

The present invention relates to a soft mold, and in particular relates to a wafer-level optical mold and fabrication thereof.

2. Description of the Related Art

To fabricate a soft mold, an elastomer is poured into a mold such that the mold is formed in an intaglio and a relief structure. The soft mold is provided to form a fine pattern for a micro or macro unit. An excellent pattern can be a printing pattern, such as an intaglio or relief pattern. For example, the soft mold may be used for a color filter layer formed on a color filter substrate of an LCD device, or for an electrode formed in an organic light-emitting diode. The soft mold may be formed of an elastic polymer, for example, polydimethylsiloxane. Polyurethane or polyimide may be used as alternatives to PDMS for the soft mold. A method for fabricating a soft mold according to the related art will be described with reference to the accompanying drawings.

FIGS. 1A to 1D are cross-sectional views illustrating a method for fabricating a soft mold according to the related art. As shown in FIG. 1A, a master mold 12 is positioned in a zig 10 for providing the printing pattern. The fabrication method of the master mold 31 includes an insulating material layer, such as silicon nitride or silicon oxide, to be deposited on an insulating substrate, and then patterned by photolithography. Thus, a predetermined pattern is formed on the insulating substrate.

As shown in FIG. 1B, an elastic polymer in prepolymer state is poured into the master mold 12 to form a prepolymer layer 14. Then, the prepolymer layer 14 is cured.

As shown in FIG. 1C, an oxygen O₂ plasma treatment is applied to the surface of the polymer layer 14 such that compounds at the surface of the polymer layer 14 are substituted with “—OH” group compounds. Subsequently, a silane coupling agent treatment is applied to the surface of the polymer layer 14 having substituted “—OH” group compounds. The silane coupling agent treatment is performed to improve adhesion between the polymer layer 14 and a later to be attached back-plane.

As shown in FIG. 1D, the zig 10 is positioned in a vacuum chamber 18. The vacuum chamber 18 is provided with a zig supporter 184, for supporting the zig 10 having the polymer layer 14, a stage 182, on which the back-plane 16 is loaded, and a stage driver, for moving the stage 182 up and down. The back-plane 16 is loaded onto the stage 182 of the vacuum chamber 18 either before or after the polymer layer 14 formed in the zig 10 is positioned in the vacuum chamber 18. Next, the stage driver of the vacuum chamber 18 moves up to attach the back-plane 16 to the rear surface of the polymer layer 14. The back-plane 16 is attached to the surface of the polymer layer 14 under a vacuum state so as to prevent bubbles from being generated between the polymer layer 14 and the back-plane 16.

However, the fabrication method of the conventional soft mold is complicated, leads to a heavier soft mold, and does not allow for soft mold thickness adjustment. Additionally, the conventional fabrication method does not have a horizontal calibration step, resulting in a soft mold with variable thicknesses and a horizontal problem. Furthermore, adhesion of the soft mold is hindered as the conventional soft mold will accumulate surplus air. Thus, a novel fabrication method and a soft mold are required to obtain a soft mold circumventing the previously mentioned problems.

### BRIEF SUMMARY OF INVENTION

The invention provides a soft mold comprising: a polymer layer having a printing pattern on a first surface thereof, at least one air channel on the first surface; and a back-plate attached to a second surface of the polymer layer.

The invention further provides a method for fabricating a soft mold. The method includes: providing a mold having a predetermined pattern; positioning the mold in a cavity and calibrating the horizontal thereof, wherein the cavity is surrounded by a dam; forming a polymer layer on the mold; attaching a back-plate to a top surface of the polymer layer and the dam; separating the polymer layer from the mold to obtain a soft mold having a patterned surface; and cutting at least one air channel on the patterned surface of the soft mold.

The invention further provides another method for fabricating a soft mold. The method includes: providing a mold having a predetermined pattern; forming at least one wall on the mold; positioning the mold in a cavity and calibrating the horizontal thereof, wherein the cavity is surrounded by a dam; forming a polymer layer on the mold; and attaching a back-plate to a top surface of the polymer layer and the dam, wherein the wall is lower than the top surface of the dam.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIGS. 1A-1D are cross-sectional views illustrating a method for fabricating a soft mold according to the related art;

FIG. 2 is a cross-sectional view illustrating a soft mold having a back-plane according to a first embodiment of the present invention;

FIGS. 3A-3G are schematic diagrams showing the steps involved in fabricating the soft mold of the invention; and

FIGS. 4A-4F are schematic diagrams showing alternative steps involved in fabricating the soft mold of the invention.

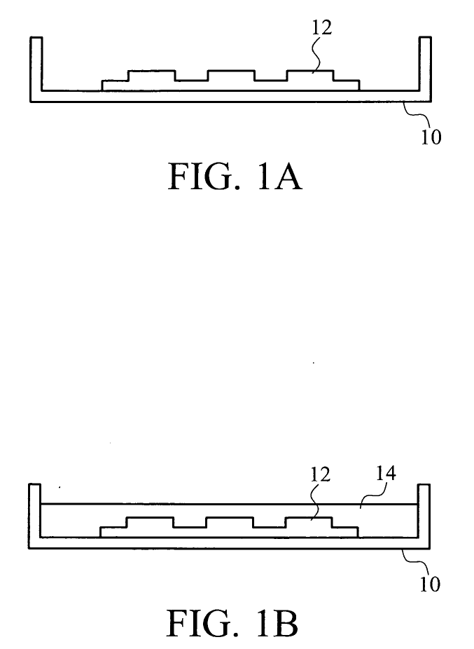

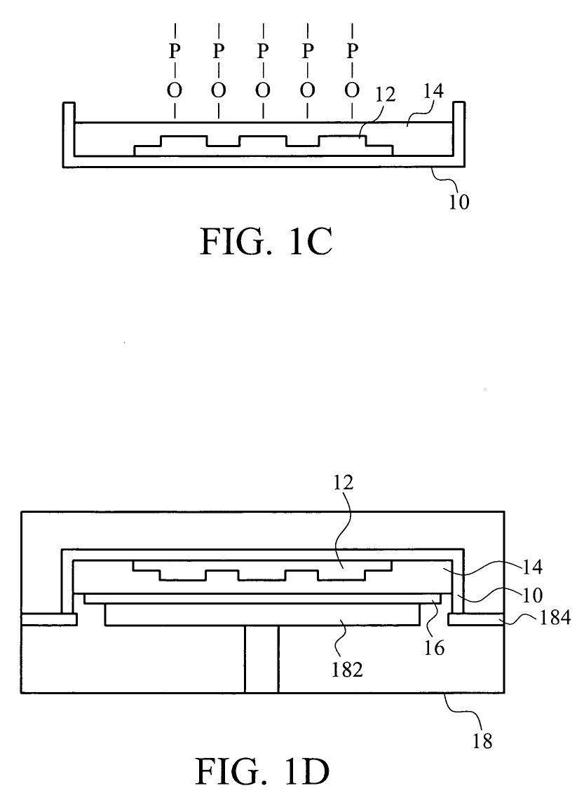

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

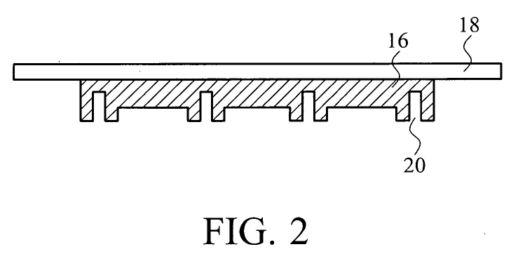

FIG. 2 illustrates an embodiment of soft mold of the invention. It should be understood that the drawings herein are made in simplicity, and are utilized for illustrating associated elements related to the invention. In practical usage however, the semiconductor package is more complexly structured.

FIG. 2 is a cross-sectional view illustrating a soft mold having a back-plate attached thereof. As shown in FIG. 2, the soft mold includes a polymer layer 16 having a surface with a printing pattern, and a back-plate 18 attached to another surface of the polymer layer 16. The polymer layer 16 can be formed by polydimethylsiloxane (PDMS), polyurethane, polyimide, epoxy, novolac or other commonly used materials. The back-plate 18 is attached to the rear surface of the polymer layer 16 to prevent handling damage and/or dimensional change when forming of the polymer layer 16. On other words, the back-plate 16 can assist in the formation of the polymer layer 16. The back-plate 18 can be a rigid material, such as plastic or glass. It should be noted that at least one air channel 20 is formed on the surface with a printing pattern of the polymer layer 16, and can release air during the replication process to improve the adhesion of the soft mold.

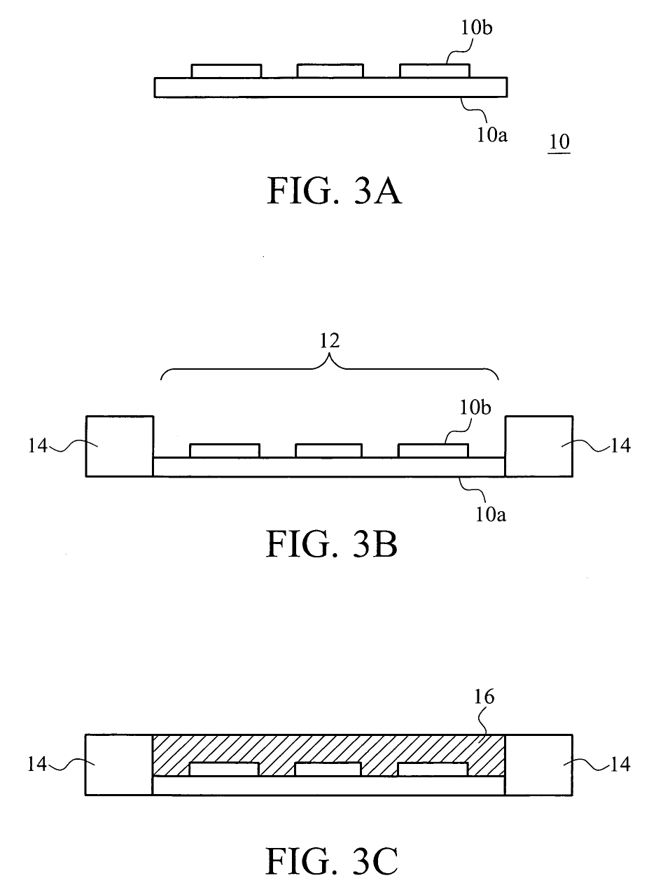

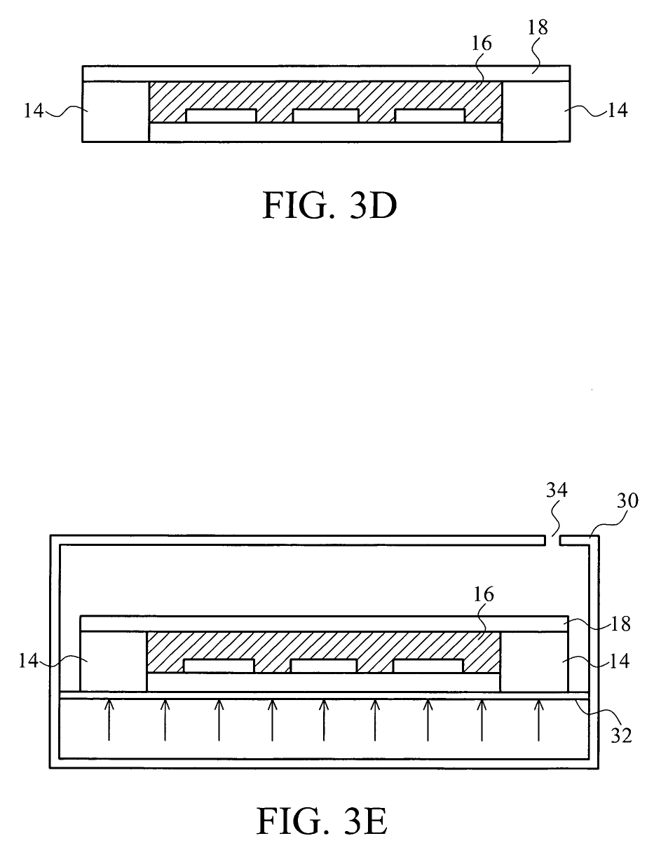

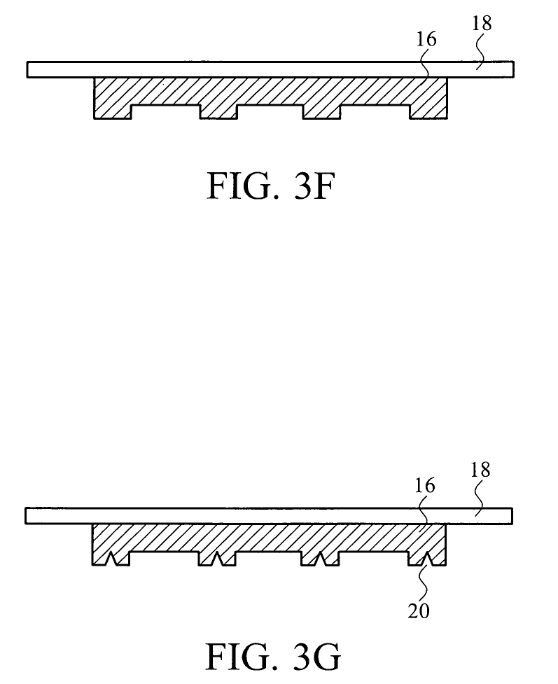

FIGS. 3A to 3F are cross-sectional views illustrating a first embodiment of a method for fabricating the soft mold of the present invention. Referring to FIG. 3A, a mold 10 is provided. A surface of the mold 10 has a desired pattern 10a, such as an intaglio or relief pattern. To form the mold 10, a material layer 10b is deposited on a substrate 10a, such as a silicon substrate, and then the insulating material layer is patterned by photolithography. Thus, a predetermined and desired pattern is formed on the substrate. The predetermined pattern can be formed by a metal (e.g., Ti, Pd, Pt, Cu, Ag, Au, In, Sn, Pb, P, As, Sb or Ni), photoresist, dielectric materials (e.g., oxide, silicon nitride, silicon oxynitride), or wax.

Referring to FIG. 3B, the mold 10 is positioned in a cavity 12, and then calibration of the horizontal of the mold 10 is performed. The cavity 12 is a concave space and surround by at least one dam(s) 14. Furthermore, in the present invention, the thickness of the polymer layer 16 can be defined by the distance between the top surface of substrate 10a and the dam(s) 14. Accordingly, anyone skilled in the art can easily obtain a polymer layer (or soft mold) having a desired thickness by regulating the height of the dam (s). After positioning the mold 10 in the cavity 12, detection and calibration of a horizontal error are performed. In one embodiment, the calibration of a horizontal error can be carried out by any common horizontal calibration apparatus.

Referring to FIG. 3C, an elastic polymer (elastic elastomer) in prepolymer state is poured into the mold 10 to form a polymer layer 16. In the present invention, any polymer material which is similar in property to the elastic polymer can be used. For example, the polymer layer 16 can be formed by polydimethylsiloxane (PDMS), polyurethane, polyimide, polyamide, fluoropolymer, polytetrafluorethylene, polystyrene, polycarbonate, or PMMA (polymethyl methacrylate), silicon nitride, epoxy, novolac, meta-cresol novolac or phenolic.

As shown in FIG. 3D, a back-plate 18 is attached onto the dam(s) 14 and polymer layer 16 before the solidification of the polymer material, so that the back-plate 18 can stably be attached to the polymer layer 16. In one embodiment, if need be, the back-plate 18 can be washed to produce OH groups on the surface of the polymer layer 16 and improve adhesion between the polymer layer 16 and the back-plate 18. In another embodiment, the back-plate can be treated with a coupling agent to improve adhesion between the polymer layer 16 and the back-plate 18. A primer may be used as the coupling agent. The back-plate 18 can be a rigid material, such as plastic or glass.

Next, before separating the polymer layer 16 from the mold 10, a molding process is carried out, such as a loading or spirting process. During the loading process, a weight force is provided from above to press the back-plate 18 (not shown). As shown in FIG. 3E, during the spirting process, the polymer layer 16 formed in the mold 10 is positioned in a vacuum chamber 30. The platform 32 of the vacuum chamber 30 supports the mold 10 having the polymer layer 16, and the platform 32 can be moved to the mold 10. The platform 32 are moved to press the back-plate 18 and mold 10 under a vacuum state so as to prevent bubbles from being generated between the polymer layer 16 and the back-plane 18 and uniform the soft mold. Even though some bubbles may be generated between the polymer layer 16 and the back-plane substrate 18, the bubbles can be removed by venting through a vacuum hole 34. The loading or spirting process not only can completely and excellently attach the back-plate 18 to the polymer layer 16, but also control the uniformity of the polymer layer 16.

As shown in FIG. 3F, the polymer layer 16 is separated from the mold 10. In one embodiment, the mold 10 and the dam 14 are peeled off of the polymer layer 16. As a result, the polymer layer 16 has one surface having the predetermined printing structure (patterned surface), either an intaglio or relief, and the other surface with the back-plate 18 attached thereto.

Referring to FIG. 3G, at least one air channel 20 is formed on the patterned surface of the polymer layer 16. The air channel 20 located on the unpatterned space(s) can release air to improve the adhesion between the soft mold and other devices (such as, glass). The air channel 20 can be formed by a chemical process, such as etching, lithography, photolithography, or other commonly used method. In another embodiment, the air channel 20 can be formed by a physical process, such as imprint, cutting and the like. The shape of the air channel 20 is not limited, such as a circular, square, oblong, triangular, polygon or other suitable shapes. Alternatively, the shape of the air channel 20 can also be variably structured as a square, curve, V-shape, groove, or a recess made with protruding portions at a bottom thereof. Additionally, the depth of the air channel 20 can exceed about 50 nM. Furthermore, although the number and the density of the air channel 20 are also not limited, the number or density of the air channel 20 will affect the air release ability. For example, the release of the air can be improved by increasing the number of air channel 20.

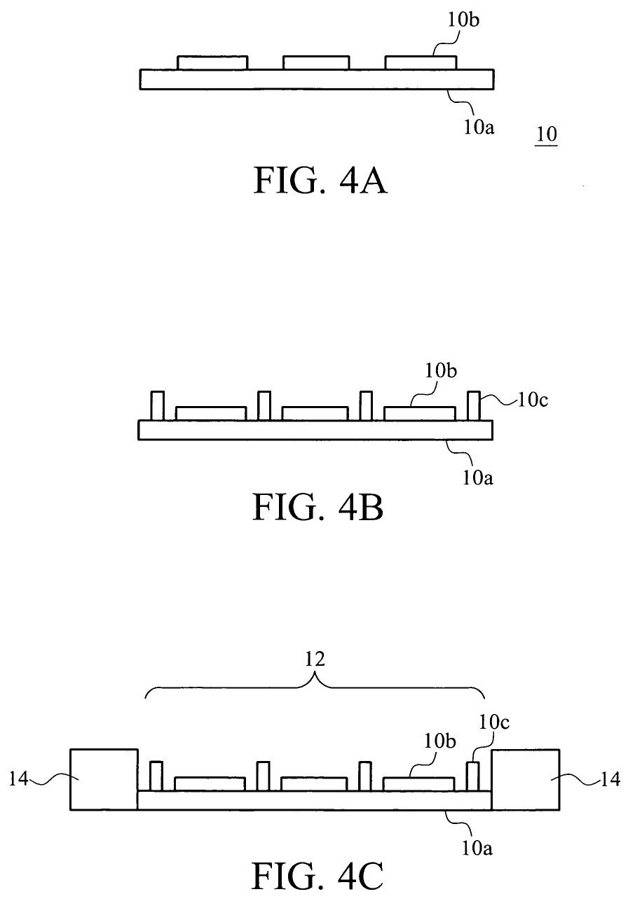

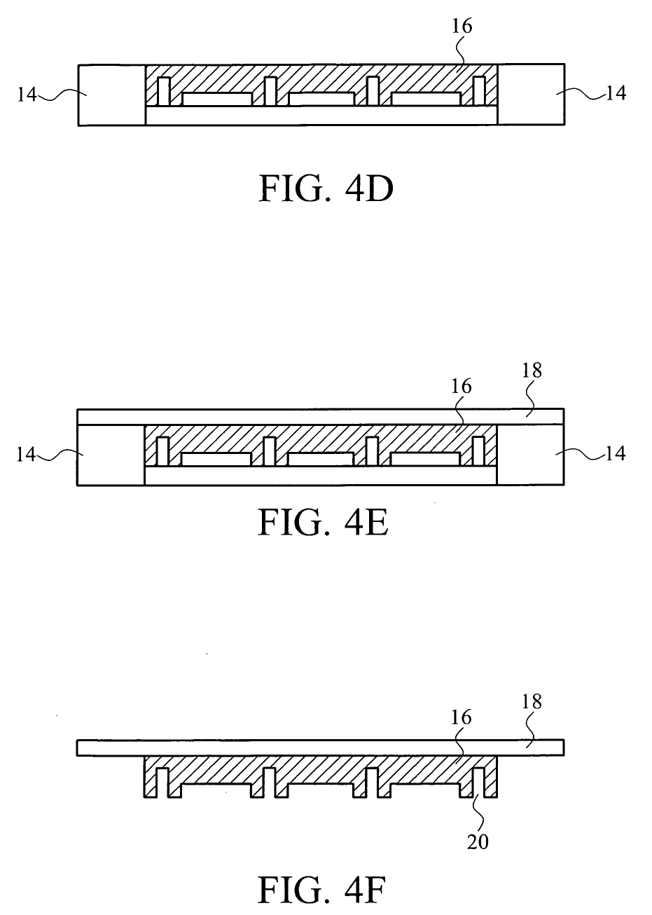

The invention further provides an alternative method for forming a soft mold as shown in FIGS. 4A to 4F. FIGS. 4A to 4F are cross-sectional views illustrating a second embodiment of a method for fabricating the soft mold of the present invention. Referring to FIG. 4A, a mold 10 is provided. A surface of the mold 10 has a desired pattern 10b. To form the mold 10, a material layer 10b is deposited on a substrate 10a, such as a silicon substrate, and then the insulating material layer is patterned by photolithography. Thus, a predetermined and desired pattern is formed on the substrate. The materials of the predetermined pattern are as previously defined in first embodiment.

Referring to FIG. 4B, at least one wall 10c is formed on the substrate 10a. As shown in FIG. 4B, the wall 10c is located between the patterns 10b, and is lower than the top surface of the dam 14 (as shown in FIG. 4C). The wall 10c can be formed by etching, lithography, photolithography, deposition, or other commonly used methods such as imprint and the like. In one embodiment, the wall 10c and patterns 10b can be formed by using the same photomask and process. In another embodiment, the wall 10c can be formed by an additional photomask and lithography process. Additionally, the wall 10c can be formed by applying the glue to the surface of the substrate 10a. The materials of the wall 10c include, but are not limited to, photosensitive composition, preferably, a negative photoresist (e.g., Kodak KTFR), a positive photoresist, such as Azoplate AZ 1350, sold by the Shipley Co., Newton, Mass., or an epoxy based photoresist such as SU-8 photoresist, or glue, such as an epoxy, acrylic, silicone or polyimide material.

Referring to FIG. 4C, the mold 10 having the pattern 10b and the wall 10c is positioned in a cavity 12, and then a calibration of the horizontal of the mold 10 is performed. As mentioned previously, the cavity 12 is a concave space and surround by at least one dam(s) 14. The height of the dam(s) 14 can be regulated depending on the different condition to obtain a polymer layer having a desired thickness. After positioning the mold 10 in the cavity 12, detection and calibration of a horizontal error are performed.

Referring to FIG. 4D, an elastic polymer (elastic elastomer) in prepolymer state is poured into the mold 10 to form a polymer layer 16. The polymer material is as previously defined in the first embodiment. For example, polydimethylsiloxane (PDMS), polyurethane, polyimide, epoxy or novolac.

Referring to FIG. 4E, a back-plate 18 is attached onto the dam(s) 14 and polymer layer 16 before the solidification of the polymer material. As mentioned above, the back-plate 18 can be washed or treated with a coupling agent before attachment. The back-plate 18 can be a rigid material, such as plastic or glass. Before separating the polymer layer 16 from the mold 10, a molding process is carried out, such as a loading or spirting process (not shown).

As shown in FIG. 4F, the polymer layer 16 is separated from the mold 10. As a result, the soft mold has one surface having the predetermined printing structure, either intaglio or relief, and the other surface with the back-plate 18 attached thereto.

As can be seem from the foregoing, an improved soft mold having air channels is provided. By forming the air channels, the soft mold can release air during the replication process to improve the adhesion between the soft mold and other devices. Additionally, the thickness and uniformity of the soft mold can be excellently controlled by the height of the dam(s) and the molding (vacuum) process. Meanwhile, in the fabrication method of the present invention, plasma or coupling agent treatments are unnecessary, since the back-plate is attached onto the dam(s) and polymer layer before the solidification of the polymer material.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A soft mold, comprising
a polymer layer having a printing pattern on a first surface thereof;
at least one air channel on the first surface; and
a back-plate attached to a second surface of the polymer layer.

2. The soft mold as claimed in claim 1, wherein the polymer layer comprises polydimethylsiloxane (PDMS), polyurethane, polyimide, polyamide, fluoropolymer, polytetrafluorethylene, polystyrene, polycarbonate, polymethyl methacrylate (PMMA), silicon nitride, epoxy, novolac, meta-cresol novolac or phenolic.

3. The soft mold as claimed in claim 1, wherein the back plate comprises plastic or glass.

4. The soft mold as claimed in claim 1, wherein the air channel is a groove.

5. The soft mold as claimed in claim 1, wherein the depth of the air channel exceeds about 50 nM.

6. A method for fabricating a soft mold, comprising
providing a mold having a predetermined pattern;
positioning the mold in a cavity and calibrating the horizontal thereof, wherein the cavity is surrounded by at least one dam;
forming a polymer layer on the mold;
attaching a back-plate to a top surface of the polymer layer and the dam;
separating the polymer layer from the mold, wherein the polymer layer has a patterned surface; and
cutting at least one air channel on the patterned surface of the polymer layer.

7. The method as claimed in claim 6, wherein the height of the dam is regulated to control the thickness of the soft mold.

8. The method as claimed in claim 6, further applying a weight force to the back-plate after attaching the back-plate to the polymer layer.

9. The method as claimed in claim 6, further positioning the polymer layer in a vacuum chamber after attaching the back-plate to the polymer layer.

10. The method as claimed in claim 6, the back-plate is attached onto the polymer layer before the solidification of the polymer material.

11. The method as claimed in claim 6, wherein the back-plate is washed before attaching to the polymer layer.

12. The method as claimed in claim 6, wherein the polymer layer comprises polydimethylsiloxane (PDMS), polyurethane, polyimide, polyamide, fluoropolymer, polytetrafluorethylene, polystyrene, polycarbonate, polymethyl methacrylate (PMMA), silicon nitride, epoxy, novolac, meta-cresol novolac or phenolic.

13. The method as claimed in claim 6, wherein the back plate comprises plastic or glass.

14. The method as claimed in claim 6, wherein the air channel is a groove.

15. A method for fabricating a soft mold, comprising
providing a mold having a predetermined pattern;
forming at least one wall on the mold;
positioning the mold in a cavity and calibrating the horizontal thereof, wherein the cavity is surrounded by at least one dam;
forming a polymer layer on the mold; and
attaching a back-plate to a top surface of the polymer layer and the dam, wherein the wall is lower than the top surface of the dam.

16. The method as claimed in claim 15, wherein the at least one wall and the predetermined pattern is formed, simultaneously.

17. The method as claimed in claim 15, the back-plate is attached onto the polymer layer before the solidification of the polymer material.

18. The method as claimed in claim 15, wherein the wall is a photoresist layer.

19. The method as claimed in claim 15, wherein the wall is a glue.

20. The method as claimed in claim 15, wherein the height of the dam is regulated to control the thickness of the soft mold.

21. The method as claimed in claim 15, further applying a weight force to the back-plate after attaching the back-plate to the polymer layer.

22. The method as claimed in claim 15, further positioning the polymer layer in a vacuum chamber after attaching the back-plate to the polymer layer.

23. The method as claimed in claim 15, wherein the back-plate is washed before attaching to the polymer layer.

24. The method as claimed in claim 15, wherein the polymer layer comprises polydimethylsiloxane (PDMS), polyurethane, polyimide, polyamide, fluoropolymer, polytetrafluorethylene, polystyrene, polycarbonate, polymethyl methacrylate (PMMA), silicon nitride, epoxy, novolac, meta-cresol novolac or phenolic.

25. The method as claimed in claim 15, wherein the back plate comprises plastic or glass.
